(19) United States
(12) Patent Application Publication
(10) Pub. No.: US 2025/0193807 A1
(43) Pub. Date: Jun. 12, 2025

(54) METHOD AND APPARATUS OF POWER HEADROOM REPORT (PHR) REPORTING

(71) Applicant: LENOVO (BEIJING) LIMITED, Beijing (CN)

(72) Inventors: Wei Ling, Beijing (CN); Yi Zhang, Beijing (CN); Chenxi Zhu, Fairfax, VA (US); Bingchao Liu, Beijing (CN); Lingling Xiao, Beijing (CN)

(21) Appl. No.: 18/841,080

(22) PCT Filed: Apr. 22, 2022
(86) PCT No.: PCT/CN2022/088526

§ 371 Date: Aug. 23, 2024

(51) Int. Cl. H04W 52/36; H04L 5/00; H04W 72/1268

(52) U.S. Cl. CPC H04W 52/365; H04L 5/0091; H04W 72/1268

(57) ABSTRACT

Embodiments of the present application are related to a method and apparatus of power headroom report (PHR) reporting. An exemplary method of the present application includes: receiving information indicating two joint or uplink common TCI states applicable in a slot of an activated bandwidth part (BWP) of a serving cell; and transmitting at least one PHR in the slot for the activated BWP of the serving cell, wherein the at least one PHR is determined at least according to a PUSCH transmission transmitted with the two joint or uplink common TCI states simultaneously in the slot.

### TECHNICAL FIELD

Embodiments of the present application generally relate to wireless communication technology, especially to a method and an apparatus of power headroom report (PHR) reporting for multiple transmit-receive point (TRP) (also referred to as multi-TRP, or M-TRP) transmission.

### BACKGROUND

Multi-TRP/panel transmission has been introduced into new radio (NR) since release 16 (Rel-16). During multi-TRP transmission, two or more TRPs (or panels) may be used to transmit data to a user equipment (UE) to improve reliability and robustness. In addition, enhancements on multiple-input multiple-output (MIMO) for NR are always discussed. A work item description (WID) approved on MIMO in NR Rel-17 includes enhancement on the support for multi-TRP deployment, targeting both frequency range (FR)1 and FR2. Wherein, a research topic is to identify and specify features to improve reliability and robustness for channels other than physical downlink shared channel (PDSCH), e.g., physical downlink control channel (PDCCH), physical uplink shared channel (PUSCH), and physical uplink control channel (PUCCH) using multi-TRP and/or multi-panel, with Rel-16 reliability features as the baseline.

Regarding PUSCH, it has been agreed that two power headroom reports can be reported for multi-TRP based PUSCH. For example, in Rel-17, up to two PHR reports are supported in M-TRP PUSCH based on spatial relation information beam indication where the two PHR reports are related to two repetitions of a PUSCH transmissions time divisional multiplexing (TDM) with different beams, and one PHR is supported based on the common beam framework. A “beam” can be represented by or associated with spatial relation information, TCI state, RS etc. However, multiple panel simultaneous uplink (UL) transmission will be discussed in Rel-18. That is, two PUSCH transmissions or one PUSCH transmission transmitted with two beams can be transmitted simultaneously.

Thus, there are still several technical problems concerning PHR reporting for multiple TRP based PUSCH needed to be solved, including but not being limited to: how to determine actual PHR reporting in single-downlink control information (DCI) (S-DCI) based M-TRP considering multiple panel simultaneous uplink (UL) transmission.

### SUMMARY OF THE APPLICATION

One objective of the embodiments of the present application is to provide a technical solution of PHR reporting, especially, a method and an apparatus of PHR reporting for multi-TRP transmission.

According to some embodiments of the present application, a user equipment (UE) is provided, which includes: a transceiver; and a processor coupled to the transceiver, wherein the processor is configured to: receive, via the transceiver, information indicating two joint or uplink common TCI states applicable in a slot of an activated bandwidth part (BWP) of a serving cell; and transmit, via the transceiver, at least one PHR in the slot for the activated BWP of the serving cell, wherein the at least one PHR is determined at least according to a PUSCH transmission transmitted with the two joint or uplink common TCI states simultaneously in the slot.

According to some embodiments of the present application, a method is provided, which includes: receiving information indicating two joint or uplink common TCI states applicable in a slot of an activated BWP of a serving cell; and transmitting at least one PHR in the slot for the activated BWP of the serving cell, wherein the at least one PHR is determined at least according to a PUSCH transmission transmitted with the two joint or uplink common TCI states simultaneously in the slot.

In some embodiments of the present application, each frequency resource block of the PUSCH transmission is transmitted with a corresponding one of the two joint or uplink common TCI state, and only one PHR in the slot is transmitted, wherein, the PHR is determined according to a first joint or uplink common TCI state of the two joint or uplink common TCI states in a codepoint of a medium access control (MAC) control element (CE) and a number of resource blocks of the PUSCH transmission associated with the first joint or uplink common TCI state.

In some embodiments of the present application, each frequency resource block of the PUSCH transmission is transmitted with a corresponding one of the two joint or uplink common TCI state, and only one PHR in the slot is transmitted, wherein, the PHR is determined according to a number of frequency resource blocks of the PUSCH transmission associated with a sounding reference signaling (SRS) resource set with a lower identifier (ID) of two SRS resource sets configured for the activated BWP and a joint or uplink common TCI state associated with the SRS resource set with the lower ID.

In some embodiments of the present application, each frequency resource block of the PUSCH transmission is transmitted with a corresponding one of the two joint or uplink common TCI state in a codepoint of a MAC CE, and only one PHR in the slot is transmitted, wherein, the PHR is determined according to a joint or uplink common TCI state of the two joint or uplink common TCI states and a number of frequency resource blocks of the PUSCH transmission associated with the joint or uplink common TCI state. The PHR is transmitted in a PHR MAC CE and at least one bit in the PHR MAC CE indicates with which joint or uplink common TCI state of the two joint or uplink common TCI states or which SRS resource set of two SRS resource sets configured for the activated BWP the PHR is associated.

In some embodiments of the present application, a part of layers of the PUSCH transmission is transmitted with a first joint or uplink common TCI state of the two joint or uplink common TCI states in a codepoint of a MAC CE and another part of the layers of the PUSCH transmission is transmitted with a second joint or uplink common TCI state of the two joint or uplink common TCI states in the codepoint of the MAC CE or each layer of the PUSCH transmission is transmitted with the two joint or uplink TCI states, and only one PHR in the slot is transmitted, wherein, the PHR is determined according to a number of resource blocks of the PUSCH transmission and the first joint or uplink common TCI state.

In some embodiments of the present application, a part of layers of the PUSCH transmission is transmitted with a first joint or uplink common TCI state of the two joint or uplink common TCI states in a codepoint of a MAC CE and another part of the layers of the PUSCH transmission is transmitted with a second joint or uplink common TCI state of the two joint or uplink common TCI states in the codepoint of the MAC CE or each layer of the PUSCH transmission is transmitted with the two joint or uplink TCI states, and only one PHR in the slot is transmitted, wherein, the PHR is determined according to a number of frequency resource blocks of the PUSCH transmission and a joint or uplink common TCI state associated with a SRS resource set with a lower ID of two SRS resource sets configured for the activated BWP.

In some embodiments of the present application, a part of layers of the PUSCH transmission is transmitted with a first joint or uplink common TCI state of the two joint or uplink common TCI states in a codepoint of a MAC CE and other part of the layers of the PUSCH transmission is transmitted with a second joint or uplink common TCI state of the two joint or uplink common TCI states in the codepoint of the MAC CE or each layer of the PUSCH transmission is transmitted with the two joint or uplink TCI states, and only one PHR in the slot is transmitted, wherein, the PHR is determined according to a joint or uplink common TCI state of the two joint or uplink common TCI states and a number of frequency resource blocks of the PUSCH transmission. The PHR is transmitted in a PHR MAC CE and at least one bit in the PHR MAC CE indicates with which joint or uplink common TCI state of the two joint or uplink common TCI states or which SRS resource set of two SRS resource sets configured for the activated BWP the PHR is associated.

In some embodiments of the present application, each frequency resource block of the PUSCH transmission is transmitted with a corresponding one of the two joint or uplink common TCI state, and two one PHRs in the slot are transmitted in a PHR MAC CE, wherein, a first PHR in the PHR MAC CE is determined according to a first joint or uplink common TCI state of the two joint or uplink common TCI states in a codepoint of a MAC CE and a number of resource blocks of the PUSCH transmission associated with the first joint or uplink common TCI state, and a second PHR in the PHR MAC CE is determined according to a second joint or uplink common TCI state of the two joint or uplink common TCI states in the codepoint of the MAC CE and a number of resource blocks of the PUSCH transmission associated with the second joint or uplink common TCI state.

In some embodiments of the present application, each frequency resource block of the PUSCH transmission is transmitted with a corresponding one of the two joint or uplink common TCI state, and two PHRs in the slot are transmitted in a PHR MAC CE, wherein, a first PHR in the PHR MAC CE is determined according to a number of frequency resource blocks of the PUSCH transmission associated with a SRS resource set with a lower ID of two SRS resource sets configured for the activated BWP and a joint or uplink common TCI state associated with the SRS resource set with the lower ID, and a second PHR in the PHR MAC CE is determined according to a number of frequency resource blocks of the PUSCH transmission associated with a SRS resource set with a higher ID of the two SRS resource sets and a joint or uplink common TCI state associated with the SRS resource set with the higher ID.

In some embodiments of the present application, a part of layers of the PUSCH transmission is transmitted with a first joint or uplink common TCI state of the two joint or uplink common TCI states in a codepoint of a MAC CE and other part of the layers of the PUSCH transmission is transmitted with a second joint or uplink common TCI state of the two joint or uplink common TCI states in the codepoint of the MAC CE or each layer of the PUSCH transmission is transmitted with the two joint or uplink TCI states, and two PHRs in the slot are transmitted in a PHR MAC CE, wherein, a first PHR in the PHR MAC CE is determined according to the first joint or uplink common TCI state and a number of resource blocks of the PUSCH transmission, and a second PHR in the PHR MAC CE is determined according to the second joint or uplink common TCI state and a number of resource blocks of the PUSCH transmission.

In some embodiments of the present application, a part of layers of the PUSCH transmission is transmitted with a first joint or uplink common TCI state of the two joint or uplink common TCI states in a codepoint of a MAC CE and other part of the layers of the PUSCH transmission is transmitted with a second joint or uplink common TCI state of the two joint or uplink common TCI states in the codepoint of the MAC CE or each layer of the PUSCH transmission is transmitted with the two joint or uplink TCI states, and two PHRs in the slot are transmitted in a PHR MAC CE, wherein, a first PHR in the PHR MAC CE is determined according to a number of frequency resource blocks of the PUSCH transmission and a joint or uplink common TCI state associated with a SRS resource set with a lower ID of two SRS resource sets configured for the activated BWP, and a second PHR in the PHR MAC CE is determined according to a number of frequency resource blocks of the PUSCH transmission and a joint or uplink common TCI state associated with a SRS resource set with a higher ID of the two SRS resource sets.

In some embodiments of the present application, a number of the at least one PHR is determined according to a radio resource control (RRC) signaling.

According to some yet other embodiments of the present application, a radio access network (RAN) node is provided, which includes: a transceiver; and a processor coupled to the transceiver, wherein the processor is configured to: transmit, via the transceiver, information indicating two joint or uplink common TCI states applicable in a slot of an activated BWP of a serving cell; and receive, via the transceiver, at least one PHR in the slot for the activated BWP of the serving cell, wherein the at least one PHR is determined at least according to a PUSCH transmission transmitted with the two joint or uplink common TCI states simultaneously in the slot.

Embodiments of the present application provide a technical solution of PHR reporting for multi-TRP transmission, supporting PHRs for multi-TRP based PUSCH in common beam framework, and thus can enhance reliability and robustness for multi-TRP based PUSCH.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to an embodiment of the present application.

FIG. 2 illustrates a flow chart of a method of PHR reporting according to some embodiments of the present application.

FIG. 3 illustrates a block diagram of an apparatus of PHR reporting according to some embodiments of the present application.

FIG. 4 illustrates a block diagram of an apparatus of PHR reporting according to some other embodiments of the present application.

### DETAILED DESCRIPTION

The detailed description of the appended drawings is intended as a description of preferred embodiments of the present application, and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE) Release 8 and so on. It is contemplated that along with the developments of network architectures and new service scenarios, all embodiments in the present application are also applicable to similar technical problems. Moreover, the terminologies recited in the present application may change, which should not affect the principle of the present application.

A wireless communication system generally includes one or more base stations (BSs) and one or more UE. Furthermore, a BS may be configured with one TRP (or panel) or more TRPs (or panels). A TRP can act like a small BS. The TRPs can communicate with each other by a backhaul link. Such backhaul link may be an ideal backhaul link or a non-ideal backhaul link. Latency of the ideal backhaul link may be deemed as zero, and latency of the non-ideal backhaul link may be tens of milliseconds and much larger, e.g., on the order of tens of milliseconds, than that of the ideal backhaul link.

In a wireless communication system, a single TRP can be used to serve one or more UE under the control of a BS. In different scenarios, a TRP may be referred to as different terms. Persons skilled in the art should understand that as 3GPP and the communication technology develop, the terminologies recited in the specification may change, which should not affect the scope of the present application. It should be understood that the TRP(s) (or panel(s)) configured for the BS may be transparent to a UE.

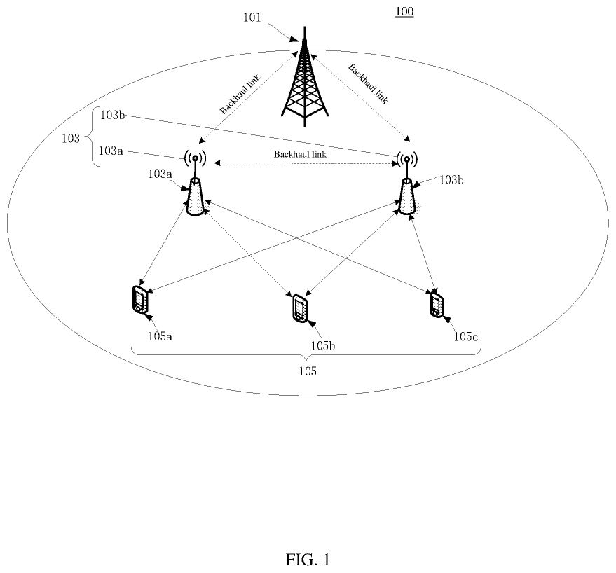

FIG. 1 is a schematic diagram illustrating an exemplary wireless communication system 100 according to some embodiments of the present application.

Referring to FIG. 1, a wireless communication system 100 can include a base station (BS) 101, TRPs 103 (e.g., a first TRP 103a and a second TRP 103b), and UEs 105 (e.g., a first UE 105a, a second UE 105b, and a third UE 105c). Although only one base station 101, two TRPs 103 and three UEs 105 are shown for simplicity, it should be noted that the wireless communication system 100 may include more or less communication device(s) or apparatus in accordance with some other embodiments of the present application.

In some embodiments of the present application, a BS 101 may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. The UEs 105 (for example, the first UE 105a, the second UE 105b, and the third UE 105c) may include, for example, but is not limited to, a computing device, a wearable device, a mobile device, an IoT device, a vehicle, etc.

The TRPs 103, for example, the first TRP 103a and the second TRP 103b can communicate with the base station 101 via, for example, a backhaul link. Each of TRPs 103 can serve some or all of UEs 105. As shown in FIG. 1, the first TRP 103a can serve some mobile stations (which include the first UE 105a, the second UE 105b, and the third UE 105c) within a serving area or region (e.g., a cell or a cell sector). The second TRP 103b can serve some mobile stations (which include the first UE 105a, the second UE 105b, and the third UE 105c) within a serving area or region (e.g., a cell or a cell sector). The first TRP 103a and the second TRP 103b can communicate with each other via, for example, a backhaul link.

A multi-TRP transmission (or operation) may refer to at least two TRPs (or panels) to transmit data to a UE. As shown in FIG. 1, for the same UE 105 (e.g., the first UE 105a, the second UE 105b, or the third UE 105c), two TRPs (e.g., the first TRP 103a and the second TRP 103b) may both transmit data to it, which is an exemplary scenario of multi-TRP transmission.

According to a WID approved on MIMO in NR Rel-18, Rel-17 unified TCI framework, i.e., common beam framework will be applied for multiple TRPs. Therefore, up to 2 common beams will be indicated by DCI in a PDCCH or a MAC CE. Hereafter, DCI in a PDCCH is also referred to a DCI. However, only one PHR is supported in common beam framework according to Rel-17 agreements. In addition, PUSCH transmission considering multiple panel simultaneous UL transmission in S-DCI based M-TRP based on common beam framework will be studied in Rel-18.

Regarding PHR reporting related to multi-TRP PUSCH, it is agreed that UE optional capability for a UE that supports multi-TRP PUSCH will be: calculating two PHRs (at least corresponding to the carrier component (CC) that applies M-TRP PUSCH repetitions), each associated with a first PUSCH occasion to each TRP, and reporting two PHRs. That is, two PHRs can be reported for multi-TRP based PUSCH. An actual Type 1 PHR report (i.e., PHR based on actual PUSCH) is drafted in TS38.213 as shown in the following:
“If a UE determines that a Type 1 power headroom report for an activated serving cell is based on an actual PUSCH transmission then, for PUSCH transmission occasion i on active UL BWP b of carrier f of serving cell c, the UE computes the Type 1 power headroom report as

$$P {H}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {a}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

where P_{CMAX,f,c}(i). P_{O_PUSCH,b,f,c}(j). M_{RB,b,f,c}^{PUSCH}(i), α_{p,f,c}(j). PL_{b,f,c}(q_{d}). Δ_{TF,b,f,c}(i) and f_{b,f,c}(i, l) are defined in clause 7.1.1. If a UE is configured with multiple cells for PUSCH transmissions, where a SCS configuration μ₁ on active UL BWP b₁ of carrier f₁ of serving cell c₁ is smaller than a SCS configuration μ₂ on active UL BWP b₂ of carrier f₂ of serving cell c₂, and if the UE provides a Type 1 power headroom report in a PUSCH transmission in a slot on active UL BWP b₁ that overlaps with multiple slots on active UL BWP b₂, the UE provides a Type 1 power headroom report for the first PUSCH, if any, on the first slot of the multiple slots on active UL BWP b₂ that fully overlaps with the slot on active UL BWP b₁. If a UE is configured with multiple cells for PUSCH transmissions, where a same SCS configuration on active UL BWP b₁ of carrier f₁ of serving cell c₁ and active UL BWP b₂ of carrier f₂ of serving cell c₂, and if the UE provides a Type 1 power headroom report in a PUSCH transmission in a slot on active UL BWP b₁, the UE provides a Type 1 power headroom report for the first PUSCH, if any, on the slot on active UL BWP b₂ that overlaps with the slot on active UL BWP b₁.
If a UE is configured with multiple cells for PUSCH transmissions and provides a Type 1 power headroom report in a PUSCH transmission with PUSCH repetition Type B having a nominal repetition that spans multiple slots on active UL BWP b₁ and overlaps with one or more slots on active UL BWP b₂, the UE provides a Type 1 power headroom report for the first PUSCH, if any, on the first slot of the one or more slots on active UL BWP b₂ that overlaps with the multiple slots of the nominal repetition on active UL BWP b₁.”

The same specification also recites:
“If a UE transmits a PUSCH associated with a first RS resource index q_{d}, as described in clause 7.1.1, on active UL BWP b of carrier f of serving cell c in slot n and is provided twoPHRMode, the UE provides a Type 1 power headroom report for PUSCH repetition associated with a second RS resource index q_{d}, as described in clause 7.1.1, where
   if the UE provides a Type 1 power headroom report for an actual PUSCH repetition associated with the first RS resource index q_{d}.
      if the UE transmits PUSCH repetitions associated with the second RS resource index q_{d} in slot n, the UE provides a Type 1 power headroom report for a first actual PUSCH repetition associated with the second RS resource index q_{d} that overlaps with slot n
      otherwise, the UE provides a Type 1 power headroom report for a reference PUSCH transmission associated with the second RS resource index q_{d}
   otherwise, if the UE provides a Type 1 power headroom report for a reference PUSCH transmission associated with the first RS resource index q_{d}, the UE provides a Type 1 power headroom report for a reference PUSCH transmission associated with the second RS resource index q_{d}.”

It can be seen from the specification that, two PHRs can be supported in S-DCI based multi-TRP PUSCH transmission where different repetitions of a PUSCH transmission are transmitted with different beams. If a two-PHR mode is not configured, then only one PHR is reported.

In conclusion, how to report PHR in S-DCI based M-TRP based on common beam framework considering multiple panel simultaneous UL transmission is not settled and will be discussed. For example, there are two repetitions of a PUSCH transmission, or two subsets of layers of a PUSCH transmission transmitted in the same symbols in a slot, e.g., frequency divisional multiplexing (FDM) or spatial divisional multiplexing (SDM), how to determine one actual PHR if only one PHR can be report, and how to determine the order of two actual PHRs in the PHR MAC CE if two PHRs can be reported. All these issues are new compared to Rel-17 PHR enhancement.

At least for solving the above technical problems, embodiments of the present application provide a technical solution of PHR reporting, e.g., a method and an apparatus of PHR reporting for multi-TRP based PUSCH. Herein, only actual PHR is discussed, and the PUSCH is always referred to as “the actual PUSCH transmission” in view of actual PHR as specified in the specification.

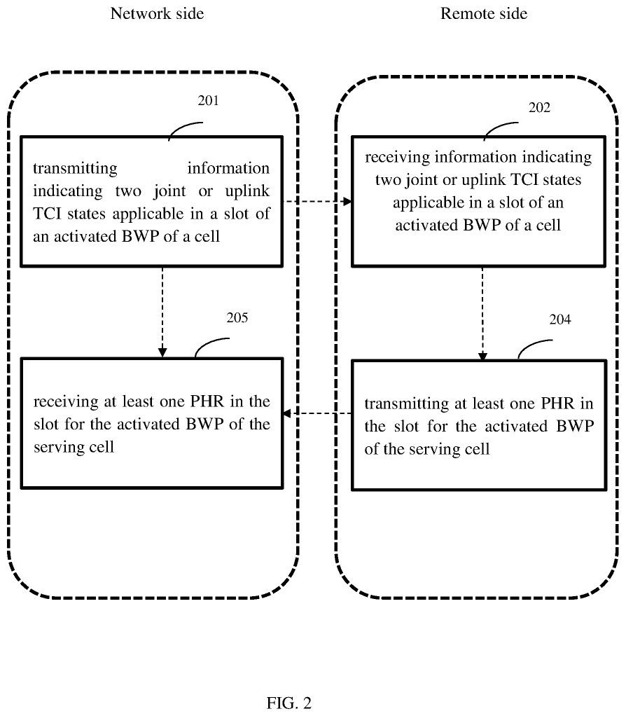

FIG. 2 illustrates a flow chart of a method of PHR reporting according to some embodiments of the present application. Although the method is illustrated in a system level by a UE in a remote side (or UE side) and a BS in a network side (or BS side), persons skilled in the art can understand that the method implemented in the remote side and that implemented in the network side can be separately implemented and incorporated by other apparatus with similar functions. In addition, no transmission or reception failure is considered in the illustrated embodiments of the present application.

Referring to FIG. 2, the network side, e.g., a gNB may transmit information indicating two joint or uplink common TCI states to the remote side, e.g., to a UE in step 201, and the UE will receive the information indicating two joint or uplink common TCI states in step 202. For example, the gNB may indicate two joint or uplink common TCI states in a codepoint (e.g., TCI codepoint) of a MAC CE activating common TCI states. A DCI may be further indicated to the UE by the gNB, and the TCI codepoint is indicated by the DCI if more than one codepoint is included in the MAC CE or is indicated by the MAC CE if only the codepoint is included in the MAC CE. In this view, the two joint or uplink common TCI states in the codepoint of a MAC CE are indicated by a DCI or MAC CE. For S-DCI based M-TRP PUSCH, at least one codepoint of the MAC CE activating joint or uplink common TCI states includes two joint or uplink common TCI states. The two joint or uplink common TCI states are respectively identified as the first joint or uplink common TCI state and the second joint or uplink common TCI state in the codepoint in sequence.

For the UE, the indicated two joint or uplink common TCI states will be applicable in a plurality of slots of an activated BWP of a cell or carrier. For a slot where the two joint or uplink common TCI states are applicable in the activated BWP, the UE will calculate (or determine) at least one PHR in the slot for the activated BWP in response to a PHR trigger event, which is indicated by an upper layer, e.g., MAC layer in the UE. The at least one PHR is at least one actual Type 1 PHR, which is determined at least according to a PUSCH transmission transmitted with the two joint or uplink common TCI states simultaneously in the slot. The UE will transmit or report the calculated at least one PHR, e.g., in a PHR MAC CE to the gNB in step 204, e.g., carried by a PUSCH transmission. Accordingly, the gNB will receive the at least one PHR in step 205, e.g., included in the PHR MAC CE.

For example, if there is at least one PUSCH transmission meeting the timeline for determining an actual PHR in the slot which is specified in TS38.213 below, then an actual PHR is determined to be reported:
“A UE determines whether a power headroom report for an activated serving cell [11, TS 38.321] is based on an actual transmission or a reference format based on the higher layer signalling of configured grant and periodic/semi-persistent sounding reference signal transmissions and downlink control information the UE received until and including the PDCCH monitoring occasion where the UE detects the first DCI format scheduling an initial transmission of a transport block since a power headroom report was triggered if the power headroom report is reported on a PUSCH triggered by the first DCI format. Otherwise, a UE determines whether a power headroom report is based on an actual transmission or a reference format based on the higher layer signalling of configured grant and periodic/semi-persistent sounding reference signal transmissions and downlink control information the UE received until the first uplink symbol of a configured PUSCH transmission minus T′proc,2=Tproc,2 where Tproc,2 is determined according to [6, TS 38.214] assuming d2, 1=1, d2,2=0, and with μDL corresponding to the subcarrier spacing of the active downlink BWP of the scheduling cell for a configured grant if the power headroom report is reported on the PUSCH using the configured grant.”

The total number of PHRs in the slot to be reported is configured by an upper layer signaling, e.g., a RRC signaling. The UE will determine to report one Type 1 PHR or two Type 1 PHRs or more for an activated BWP of a serving cell according to the RRC signaling. For example, if the parameter “twoPHRMode” is enabled in the serving cell, then two PHRs will be reported for the serving cell; otherwise, only one PHR will be reported for the serving cell. Given that, besides the at least one actual PHR, there may be at least one virtual PHR to be reported in some scenarios. For example, the RRC signaling may indicate two PHRs in the slot for the activated BWP will be reported, i.e., the parameter “twoPHRMode” being enabled, while only one actual PHR is determined in the UE, and then a virtual PHR will be included in the PHR MAC CE with the actual PHR. As stated above, only actual Type 1 PHR(s), i.e., actual PHR(s) determined based on actual PUSCH transmission(s) under the common beam framework is discussed.

Specifically, considering that multiple panel simultaneous uplink transmission is supported in S-DCI based M-TRP and two joint or uplink common TCI states are indicated by a DCI or a MAC CE for PUSCH for an activated BWP of a serving cell, schemes of PHR reporting will be illustrated in detail in view of different scenarios according to some embodiments of the present application.

### Scenario 1: Only One PHR to be Reported

In some scenarios, the UE is indicated to report only one PHR, e.g., by a RRC signaling. For example, the parameter “twoPHRMode” is disabled or not configured. That is, the UE needs to provide one Type 1 PHR for an activated BWP of a serving cell in a slot according to a PHR triggering event. The PHR can be reported in a legacy procedure as specified in TS38.213 in a PHR MAC CE.

When the PUSCH transmission starting earliest in the slot is transmitted with one joint or uplink common TCI state, the actual PHR for the serving cell is calculated according to the PUSCH transmission starting earliest which is as the same as the legacy procedure.

When the PUSCH transmission starting earliest in the slot is transmitted with two joint or uplink common TCI states in a codepoint of a MAC CE simultaneously, there are three exemplary cases, i.e., FDM based PUSCH, SDM based PUSCH and single frequency network (SFN) based PUSCH where the PUSCH transmission is transmitted with two joint or uplink common TCI states simultaneously as follows.

### Case 1: FDM Based PUSCH

In Case 1, a PUSCH transmission is transmitted with two joint or uplink common TCI states in a slot where each frequency resource block of the PUSCH transmission is transmitted with a corresponding one of the two joint or uplink common TCI states.

According to some embodiments of the present application, the one actual PHR is determined according to the first joint or uplink common TCI state and the number of the frequency resource blocks associated with the first joint or uplink common TCI state.

For example, the UE needs to provide a Type 1 PHR in slot n for an activated uplink BWP of a serving cell according to a PHR triggering event. There is one PUSCH transmission transmitted with two uplink common TCI states, i.e., the first uplink common TCI state, e.g., TCI state 1 and the second uplink common TCI state, e.g., TCI state 2 with a FDM manner in the slot meeting the timeline for determining an actual PHR in the slot. Besides, the PUSCH transmission has two FDM parts, where the first and second parts have K1 resource blocks transmitted with TCI state 1 and K2 resource blocks transmitted with TCI state 2 respectively. Then, the actual PHR for the activated BWP in the slot is based on K1 and TCI state 1.

According to some other embodiments of the present application, the only one actual PHR will be determined according to the number of the frequency resource blocks associated with the first SRS resource set of two SRS resource sets and the joint or uplink common TCI state associated with the first SRS resource set. The two SRS resource sets are configured for the activated BWP of the serving cell, wherein the SRS resource set with a lower ID is identified as the first SRS resource set and the SRS resource set with a higher ID is identified as the second SRS resource set. There is a one to one mapping or association relationship between the two SRS resource sets and the two joint or uplink common TCI states, which can be configured by a RRC signaling or indicated by a MAC CE or a DCI etc. For example, the first SRS resource set is associated with the second joint or uplink common TCI state, and the second SRS resource set is associated with the first joint or uplink common TCI state. In another example, the first SRS resource set is associated with the first joint or uplink common TCI state, and the second SRS resource set is associated with the second joint or uplink common TCI state. Therefore, all the frequency resource blocks of the PUSCH transmission associated with the first SRS resource set are transmitted with one of the two joint or uplink common TCI states, and all the frequency resource blocks of the PUSCH transmission associated with the second SRS resource set are transmitted with the other one of the two joint or uplink common TCI states.

For example, the UE needs to provide a Type 1 PHR in slot n for an activated uplink BWP of a serving cell according to a PHR triggering event. There is one PUSCH transmission transmitted with two uplink common TCI states, i.e., the first uplink common TCI state, e.g., TCI state 1 and the second uplink common TCI state, e.g., TCI state 2 with a FDM manner in the slot meeting the timeline for determining an actual PHR in the slot. Besides, the PUSCH transmission has two FDM parts, where the first part has K1 resource blocks associated with the second SRS resource set and the second part has K2 resource blocks associated with the first resource set respectively. In addition, the first SRS resource set is associated with the second TCI state, e.g., TCI state 2, and the second SRS resource set is associated with the first TCI state, e.g., TCI state 1. Then, the actual PHR for the activated BWP in the slot is based on K2 and TCI state 2.

According to some yet other embodiments of the present application, the only one actual PHR will be determined according to a joint or uplink common TCI state of the two joint or uplink common TCI states and the number of the frequency resource blocks associated with the corresponding joint or uplink common TCI state. The PHR MAC CE will include at least one bit to indicate with which joint or uplink common TCI state or which SRS resource set the actual PHR is associated. For example, the bit in the PHR MAC CE set to “0” indicates that an actual PHR is associated with the first joint or uplink common TCI state and “1” indicates that an actual PHR is associated with the second joint or uplink common TCI state, vice versa. For another example, the bit in the PHR MAC CE set to “0” indicates that an actual PHR is associated with one joint or uplink common TCI state associated with the first SRS resource set and “1” indicates that an actual PHR is associated with the other joint or uplink common TCI state associated with the second SRS resource set, vice versa.

For example, the UE needs to provide a Type 1 PHR in slot n for an activated uplink BWP of a serving cell according to a PHR triggering event. There is one PUSCH transmission transmitted with two uplink common TCI states, i.e., the first uplink common TCI state, e.g., TCI state 1 and the second uplink common TCI state, e.g., TCI state 2 with a FDM manner in the slot meeting the timeline for determining an actual PHR in the slot. Besides, the PUSCH transmission has two FDM parts, where the first and second parts have K1 resource blocks transmitted with TCI state 1 and K2 resource blocks transmitted with TCI state 2 respectively. If, the actual PHR for the activated BWP in the slot is based on K2 and TCI state 2, then the corresponding bit in the PHR MAC CE is set to “1” to indicate that the actual PHR is associated with the second TCI state.

### Case 2: SDM Based PUSCH

In Case 2, a PUSCH transmission is transmitted with two joint or uplink common TCI states in a slot where some layers of the PUSCH transmission are transmitted with the first joint or uplink common TCI state while the remaining layers of the PUSCH transmission are transmitted with the second joint or uplink common TCI state. That is, a part of layers of the PUSCH transmission is associated with the first joint or uplink TCI state and the other part of layers of the PUSCH transmission is associated with the second joint or uplink TCI state.

According to some embodiments of the present application, the actual PHR is determined according to the number of the frequency resource blocks of the PUSCH transmission and the first joint or uplink common TCI state.

According to some other embodiments of the present application, the actual PHR is determined according to the number of the frequency resource blocks of the PUSCH transmission and a joint or uplink common TCI state of the two joint or uplink common TCI states associated with the first SRS resource set of two SRS resource sets configured for the activated BWP of the serving cell. The SRS resource set with a lower ID is identified as the first SRS resource set and the SRS resource set with a higher ID is identified as the second SRS resource set. There is a one to one mapping or association relationship between the two SRS resource sets and the two joint or uplink common TCI states, which can be configured by a RRC signaling or indicated by a MAC CE or a DCI etc. For example, the first SRS resource set is associated with the second joint or uplink common TCI state, and the second SRS resource set is associated with the first joint or uplink common TCI state. In another example, the first SRS resource set is associated with the first joint or uplink common TCI state, and the second SRS resource set is associated with the second joint or uplink common TCI state. Therefore, all the part of layers of the PUSCH transmission associated with the first SRS resource set is transmitted with one joint or uplink common TCI state of the two joint or uplink common TCI states, and all the other part of layers of the PUSCH transmission associated with the second SRS resource set is transmitted with the other joint or uplink common TCI state of the two joint or uplink common TCI states.

According to some yet other embodiments of the present application, the actual PHR is determined according to a joint or uplink common TCI state of the two joint or uplink common TCI states and the number of the frequency resource blocks of the PUSCH transmission. Similarly, the PHR MAC CE will include at least one bit to indicate with which joint or uplink common TCI state or which SRS resource set the actual PHR is associated. For example, the bits in the PHR MAC CE set to “00” indicate that the actual PHR is associated with the first joint or uplink common TCI state and “01” indicate that the actual PHR is associated with the second joint or uplink common TCI state respectively, vice versa. For another example, the bits in the PHR MAC CE set to “00” and “01” indicate that the actual PHR is associated with a joint or uplink common TCI state associated with the first and second SRS resource set respectively, vice versa.

### Case 3: SFN Based PUSCH

In Case 3, a PUSCH transmission is transmitted with two joint or uplink common TCI states in a slot, where each layer of the PUSCH transmission is transmitted with the two joint or uplink common TCI states. For SFN based PUSCH, a solution of reporting one PHR is similar to that for SDM based PUSCH.

For example, according to some embodiments of the present application, the actual PHR is determined according to the number of the frequency resource blocks of the PUSCH transmission and the first joint or uplink common TCI state.

According to some other embodiments of the present application, the actual PHR is determined according to the number of the frequency resource blocks of the PUSCH transmission and a joint or uplink common TCI state of the two joint or uplink common TCI states associated with the first SRS resource set of two SRS resource sets. The two SRS resource sets are configured for the activated BWP of the serving cell, wherein the SRS resource set with a lower ID is identified as the first SRS resource set and the SRS resource set with a higher ID is identified as the second SRS resource set. There is a one to one mapping or association relationship between the two SRS resource sets and the two joint or uplink common TCI states, which can be configured by a RRC signaling or indicated by a MAC CE or a DCI etc. The PUSCH transmission is associated with the two SRS resource sets simultaneously.

According to some yet other embodiments of the present application, the actual PHR is determined according to a joint or uplink common TCI state of the two joint or uplink common TCI states and the number of the frequency resource blocks of the PUSCH transmission. Similarly, the PHR MAC CE will include at least one bit to indicate with which joint or uplink common TCI state or which SRS resource set the actual PHR is associated.

### Scenario: Two PHRs to be Reported

In some scenarios, the UE is indicated to report two PHRs, e.g., by a RRC signaling. For example, the parameter “twoPHRMode” is enabled. That is, the UE needs to provide two Type 1 PHRs for an activated BWP of a serving cell in a slot according to a PHR triggering event. The two PHRs can be reported in a legacy procedure as specified in TS38.213 in a PHR MAC CE. Thus, besides how to determine two actual PHRs, how to determine the order of the two actual PHRs for the activated BWP of the serving cell in the PHR MAC CE also needs to be solved.

When the PUSCH transmission starting earliest in the slot is transmitted with two joint or uplink common TCI states of a codepoint of a MAC CE simultaneously, two actual PHRs will be determined according to the actual PHR transmission. Similarly, there are three cases, i.e., FDM based PUSCH, SDM PUSCH and SFN based PUSCH.

### Case 1: FDM Based PUSCH

In Case 1, a PUSCH transmission is transmitted with two joint or uplink common TCI states in a slot where each frequency resource block of the PUSCH transmission is transmitted with a corresponding one of the two joint or uplink common TCI states.

According to some embodiments of the present application, the first actual PHR in the PHR MAC CE is determined according to the first joint or uplink common TCI state and the number of the frequency resource blocks associated with the first joint or uplink common TCI state; and the second actual PHR in the PHR MAC CE is determined according to the second joint or uplink common TCI state and the number of the frequency resource blocks associated with second first joint or uplink common TCI state.

According to some other embodiments of the present application, the first actual PHR in the PHR MAC CE will be determined according to the number of the frequency resource blocks associated with the first SRS resource set of two SRS resource sets and the joint or uplink common TCI state associated with the first SRS resource set; and the second actual PHR in the PHR MAC CE will be determined according to the number of the frequency resource blocks associated with the second SRS resource set of the two SRS resource sets and the joint or uplink common TCI state associated with the second SRS resource set. The two SRS resource sets are configured for the activated BWP of the serving cell, wherein the SRS resource set with a lower ID is identified as the first SRS resource set and the SRS resource set with a higher ID is identified as the second SRS resource set. There is a one to one mapping or association relationship between the two SRS resource sets and the two joint or uplink common TCI states, which can be configured by a RRC signaling or indicated by a MAC CE or a DCI etc. Therefore, all the frequency resource blocks of the PUSCH transmission associated with the first SRS resource set are transmitted with one of the two joint or uplink common TCI states, and all the frequency resource blocks of the PUSCH transmission associated with the second SRS resource set are transmitted with the other one of the two joint or uplink common TCI states.

### Case 2: SDM Based PUSCH

In Case 2, a PUSCH transmission is transmitted with two joint or uplink common TCI states in a slot where some layers of the PUSCH transmission are transmitted with the first joint or uplink common TCI state while the remaining layers of the PUSCH transmission are transmitted with the second joint or uplink common TCI state. That is, a part of layers of the PUSCH transmission is associated with the first joint or uplink TCI state and the other part of layers of the PUSCH transmission is associated with the second joint or uplink TCI state.

According to some embodiments of the present application, the first PHR in the PHR MAC CE is determined according to the number of the frequency resource blocks of the PUSCH transmission and the first joint or uplink common TCI state; and the second PHR in the PHR MAC CE is determined according to the number of the frequency resource blocks of the PUSCH transmission and the second joint or uplink common TCI state.

For example, the UE needs to provide two Type 1 PHRs in slot n for an activated uplink BWP of a serving cell according to a PHR triggering event. There is a PUSCH transmission with four layers transmitted with two uplink common TCI states, i.e., the first uplink common TCI state, e.g., TCI state 1 and the second uplink common TCI state, e.g., TCI state 2 with the SDM manner in the slot meeting the timeline for determining an actual PHR in the slot. Besides, the first 2 layers of the PUSCH transmission is transmitted with TCI state 1 and the last 2 layers of the PUSCH transmission is transmitted with TCI state 2. The number of resource blocks of the PUSCH transmission is K. Then, the first actual PHR for the activated BWP in the slot is based on K and TCI state 1, and the second actual PHR for the serving cell in the slot is based on K and TCI state 2.

According to some other embodiments of the present application, the first PHR in the PHR MAC CE is determined according to the number of the frequency resource blocks of the PUSCH transmission and a joint or uplink common TCI state of the two joint or uplink common TCI states associated with the first SRS resource set of two SRS resource sets; and the second PHR in the PHR MAC CE is determined according to the number of the frequency resource blocks of the PUSCH transmission and the other joint or uplink common TCI state associated with the second SRS resource set of the two SRS resource sets. The two SRS resource sets are configured for the activated BWP of the serving cell SRS resource set, wherein the SRS resource set with a lower ID is identified as the first SRS resource set and the SRS resource set with a higher ID is identified as the second SRS resource set. There is a one to one mapping or association relationship between the two SRS resource sets and the two joint or uplink common TCI states, which can be configured by a RRC signaling or indicated by a MAC CE or a DCI etc. All the part of layers of the PUSCH transmission associated with the first SRS resource set is transmitted with one joint or uplink common TCI state of the two joint or uplink common TCI states, and all the other part of layers of the PUSCH transmission associated with the second SRS resource set is transmitted with the other joint or uplink common TCI state of the two joint or uplink common TCI states.

For example, the UE needs to provide two Type 1 PHRs in slot n for an activated uplink BWP of a serving cell according to a PHR triggering event. There is a PUSCH transmission with four layers transmitted with two uplink common TCI states, i.e., the first uplink common TCI state, e.g., TCI state 1 and the second uplink common TCI state, e.g., TCI state 2 with the SDM manner in the slot meeting the timeline for determining an actual PHR in the slot. Besides, the PUSCH transmission is associated with two SRS resource sets, wherein the first 2 layers of the PUSCH transmission are associated with the second SRS resource set and the last 2 layers of the PUSCH transmission are associated with the first SRS resource set. Thus, the first SRS resource set is associated with TCI state 2, and the second SRS resource set is associated with TCI state 1 respectively. Then, the first actual PHR in the slot is based on K and TCI state 2 and the second actual PHR in the slot is based on K and TCI state 1.

### Case 3: SFN Based PUSCH

In Case 3, a PUSCH transmission is transmitted with two joint or uplink common TCI states in a slot, where each layer of the PUSCH transmission is transmitted with the two joint or uplink common TCI states. For SFN based PUSCH, a solution of reporting two PHRs similar to SFN based PUSCH can be applied.

According to some embodiments of the present application, the first PHR in the PHR MAC CE is determined according to the number of the frequency resource blocks of the PUSCH transmission and the first joint or uplink common TCI state, and the second PHR in the PHR MAC CE is determined according to the number of the frequency resource blocks of the PUSCH transmission and the second joint or uplink common TCI state.

According to some other embodiments of the present application, the first PHR in the PHR MAC CE is determined according to the number of the frequency resource blocks of the PUSCH transmission and a joint or uplink common TCI state of the two joint or uplink common TCI states associated with the first SRS resource set of two SRS resource sets; and the second PHR in the PHR MAC CE is determined according to the number of the frequency resource blocks of the PUSCH transmission and the other joint or uplink common TCI state of the two joint or uplink common TCI states associated with the second SRS resource set of the two SRS resource sets. The two SRS resource sets are configured for the activated BWP of the serving cell, wherein the SRS resource set with a lower ID is identified as the first SRS resource set and the SRS resource set with a higher ID is identified as the second SRS resource set. There is a one to one mapping or association relationship between the two SRS resource sets and the two joint or uplink common TCI states, which can be configured by a RRC signaling or indicated by a MAC CE or a DCI etc. The PUSCH transmission is transmitted associated with the two SRS resource sets simultaneously.

Persons skilled in the art should well know that although up to two PHRs are illustrated, the illustrated schemes can also be applied to scenarios of reporting more than two PHRs as 3GPP develops, and should not limit the solution of the present application to the specific embodiments.

Besides the methods, embodiments of the present application also propose an apparatus of PHR reporting.

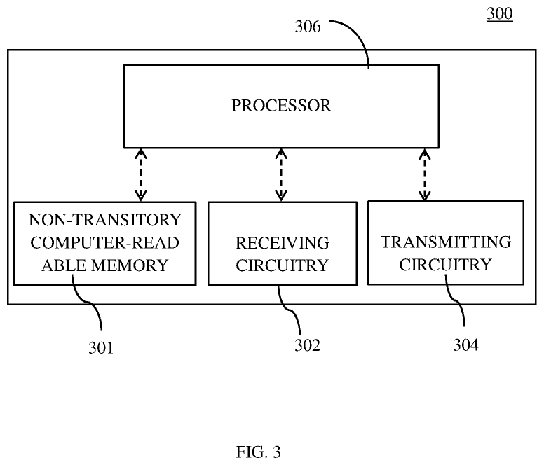

For example, FIG. 3 illustrates a block diagram of an apparatus of PHR reporting 300 according to some embodiments of the present application.

As shown in FIG. 3, the apparatus 300 may include at least one non-transitory computer-readable medium 301, at least one receiving circuitry 302, at least one transmitting circuitry 304, and at least one processor 306 coupled to the non-transitory computer-readable medium 301, the receiving circuitry 302 and the transmitting circuitry 304. The at least one processor 306 may be a CPU, a DSP, a microprocessor etc. The apparatus 300 may be a RAN node, e.g., a gNB or a remote apparatus, e.g., UE configured to perform a method illustrated in the above or the like.

Although in this figure, elements such as the at least one processor 306, transmitting circuitry 304, and receiving circuitry 302 are described in the singular, the plural is contemplated unless a limitation to the singular is explicitly stated. In some embodiments of the present application, the receiving circuitry 302 and the transmitting circuitry 304 can be combined into a single device, such as a transceiver. In certain embodiments of the present application, the apparatus 300 may further include an input device, a memory, and/or other components.

In some embodiments of the present application, the non-transitory computer-readable medium 301 may have stored thereon computer-executable instructions to cause a processor to implement the method with respect to the network apparatus as described above. For example, the computer-executable instructions, when executed, cause the processor 306 interacting with receiving circuitry 302 and transmitting circuitry 304, so as to perform the steps with respect to the RAN node or network apparatus, e.g., a gNB as depicted above.

In some embodiments of the present application, the non-transitory computer-readable medium 301 may have stored thereon computer-executable instructions to cause a processor to implement the method with respect to the UE as described above. For example, the computer-executable instructions, when executed, cause the processor 306 interacting with receiving circuitry 302 and transmitting circuitry 304, so as to perform the steps with respect to the UE as illustrated above.

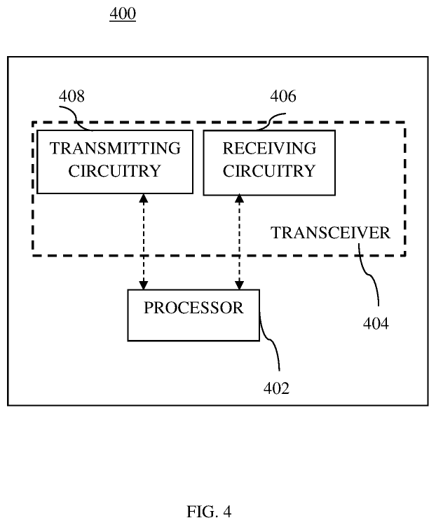

FIG. 4 is a block diagram of an apparatus of PHR reporting according to some other embodiments of the present application.

Referring to FIG. 4, the apparatus 400, for example a gNB or a UE may include at least one processor 402 and at least one transceiver 404 coupled to the at least one processor 402. The transceiver 404 may include at least one separate receiving circuitry 406 and transmitting circuitry 404, or at least one integrated receiving circuitry 406 and transmitting circuitry 404. The at least one processor 402 may be a CPU, a DSP, a microprocessor etc.

According to some embodiments of the present application, when the apparatus 400 is a remote apparatus, e.g., a UE, the processor is configured to: receive, via the transceiver, information indicating two joint or uplink TCI states applicable in a slot of an activated BWP of a serving cell; and transmit, via the transceiver, at least one PHR in the slot for the activated BWP of the serving cell, wherein the at least one PHR is determined at least according to a PUSCH transmission transmitted with the two joint or uplink common TCI states simultaneously in the slot.

According to some other embodiments of the present application, when the apparatus 400 is a RAN node, e.g., a gNB, the processor may be configured to: transmit, via the transceiver, information indicating two TCI states applicable in a slot of an activated BWP of a serving cell; and receive, via the transceiver, at least one PHR in the slot for an activated BWP of a serving cell, wherein the at least one PHR is determined at least according to a PUSCH transmission transmitted with the two joint or uplink common TCI states simultaneously in the slot.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE), comprising:
at least one memory; and
at least one processor coupled with the at least one memory and configured to cause the UE to:
receive information indicating two joint or uplink common transmission configuration indication (TCI) states applicable in a slot of an activated bandwidth part (BWP) of a serving cell; and
transmit at least one power headroom report (PHR) in the slot for the activated BWP of the serving cell, wherein the at least one PHR is determined at least according to a physical uplink shared channel (PUSCH) transmission transmitted with the two joint or uplink common TCI states simultaneously in the slot.

2. The UE of claim 1, wherein,
each frequency resource block of the PUSCH transmission is transmitted with a corresponding one of the two joint or uplink common TCI state, and only one PHR in the slot is transmitted,
wherein, the PHR is determined according to a first joint or uplink common TCI state of the two joint or uplink common TCI states and a number of resource blocks of the PUSCH transmission associated with the first joint or uplink common TCI state.

3. The UE of claim 1, wherein,
each frequency resource block of the PUSCH transmission is transmitted with a corresponding one of the two joint or uplink common TCI state, and only one PHR in the slot is transmitted,
wherein, the PHR is determined according to a number of frequency resource blocks of the PUSCH transmission associated with a sounding reference signaling (SRS) resource set with a lower identifier (ID) of two SRS resource sets configured for the activated BWP and a joint or uplink common TCI state associated with the SRS resource set with the lower ID.

4. The UE of claim 1, wherein,
each frequency resource block of the PUSCH transmission is transmitted with a corresponding one of the two joint or uplink common TCI state, and only one PHR in the slot is transmitted,
wherein, the PHR is determined according to a joint or uplink common TCI state of the two joint or uplink common TCI states and a number of frequency resource blocks of the PUSCH transmission associated with the joint or uplink common TCI state.

5. The UE of claim 1, wherein,
a part of layers of the PUSCH transmission is transmitted with a first joint or uplink common TCI state of the two joint or uplink common TCI states and another part of the layers of the PUSCH transmission is transmitted with a second joint or uplink common TCI state of the two joint or uplink common TCI states or each layer of the PUSCH transmission is transmitted with the two joint or uplink TCI states, and only one PHR in the slot is transmitted,
wherein, the PHR is determined according to a number of resource blocks of the PUSCH transmission and the first joint or uplink common TCI state.

6. The UE of claim 1, wherein,
a part of layers of the PUSCH transmission is transmitted with a first joint or uplink common TCI state of the two joint or uplink common TCI states and another part of the layers of the PUSCH transmission is transmitted with a second joint or uplink common TCI state of the two joint or uplink common TCI states or each layer of the PUSCH transmission is transmitted with the two joint or uplink TCI states, and only one PHR in the slot is transmitted,
wherein, the PHR is determined according to a number of frequency resource blocks of the PUSCH transmission and a joint or uplink common TCI state associated with a sounding reference signaling (SRS) resource set with a lower identifier (ID) of two SRS resource sets configured for the activated BWP.

7. The UE of claim 1, wherein,
a part of layers of the PUSCH transmission is transmitted with a first joint or uplink common TCI state of the two joint or uplink common TCI states and other part of the layers of the PUSCH transmission is transmitted with a second joint or uplink common TCI state of the two joint or uplink common TCI states or each layer of the PUSCH transmission is transmitted with the two joint or uplink TCI states, and only one PHR in the slot is transmitted,
wherein, the PHR is determined according to a joint or uplink common TCI state of the two joint or uplink common TCI states and a number of frequency resource blocks of the PUSCH transmission.

8. The UE of claim 1, wherein,
each frequency resource block of the PUSCH transmission is transmitted with a corresponding one of the two joint or uplink common TCI state, and two one PHRs in the slot are transmitted in a PHR medium access control (MAC) control element (CE),
wherein, a first PHR in the PHR MAC CE is determined according to a first joint or uplink common TCI state of the two joint or uplink common TCI states and a number of resource blocks of the PUSCH transmission associated with the first joint or uplink common TCI state, and a second PHR in the PHR MAC CE is determined according to a second joint or uplink common TCI state of the two joint or uplink common TCI states and a number of resource blocks of the PUSCH transmission associated with the second joint or uplink common TCI state.

9. The UE of claim 1, wherein,
each frequency resource block of the PUSCH transmission is transmitted with a corresponding one of the two joint or uplink common TCI state, and two PHRs in the slot are transmitted in a PHR medium access control (MAC) control element (CE),
wherein, a first PHR in the PHR MAC CE is determined according to a number of frequency resource blocks of the PUSCH transmission associated with a sounding reference signaling (SRS) resource set with a lower identifier (ID) of two SRS resource sets configured for the activated BWP and a joint or uplink common TCI state associated with the SRS resource set with the lower ID, and a second PHR in the PHR MAC CE is determined according to a number of frequency resource blocks of the PUSCH transmission associated with a SRS resource set with a higher ID of the two SRS resource sets and a joint or uplink common TCI state associated with the SRS resource set with the higher ID.

10. The UE of claim 1, wherein,
a part of layers of the PUSCH transmission is transmitted with a first joint or uplink common TCI state of the two joint or uplink common TCI states and other part of the layers of the PUSCH transmission is transmitted with a second joint or uplink common TCI state of the two joint or uplink common TCI states or each layer of the PUSCH transmission is transmitted with the two joint or uplink TCI states, and two PHRs in the slot are transmitted in a PHR MAC CE,
wherein, a first PHR in the PHR MAC CE is determined according to the first joint or uplink common TCI state and a number of resource blocks of the PUSCH transmission, and a second PHR in the PHR MAC CE is determined according to the second joint or uplink common TCI state and a number of resource blocks of the PUSCH transmission.

11. The UE of claim 1, wherein,
a part of layers of the PUSCH transmission is transmitted with a first joint or uplink common TCI state of the two joint or uplink common TCI states and other part of the layers of the PUSCH transmission is transmitted with a second joint or uplink common TCI state of the two joint or uplink common TCI states or each layer of the PUSCH transmission is transmitted with the two joint or uplink TCI states, and two PHRs in the slot are transmitted in a PHR MAC CE,
wherein, a first PHR in the PHR MAC CE is determined according to a number of frequency resource blocks of the PUSCH transmission and a joint or uplink common TCI state associated with a sounding reference signaling (SRS) resource set with a lower identifier (ID) of two SRS resource sets configured for the activated BWP, and a second PHR in the PHR MAC CE is determined according to a number of frequency resource blocks of the PUSCH transmission and a joint or uplink common TCI state associated with a SRS resource set with a higher ID of the two SRS resource sets.

12. The UE of claim 4 or 7, wherein, the PHR is transmitted in a PHR MAC CE and at least one bit in the PHR MAC CE indicates with which joint or uplink common TCI state of the two joint or uplink common TCI states or which sounding reference signaling (SRS) resource set of two SRS resource sets configured for the activated BWP the PHR is associated.

13. The UE of claim 1, wherein, a total number of PHRs including the at least one PHR is determined according to a radio resource control (RRC) signaling.

14. A radio access network (RAN) node, comprising:
at least one memory; and
at least one processor coupled with the at least one memory and configured to cause the RAN node to:
transmit information indicating two joint or uplink common transmission configuration indication (TCI) states applicable in a slot of an activated bandwidth part (BWP) of a serving cell; and
receive at least one power headroom report (PHR) in the slot for the activated BWP of the serving cell, wherein the at least one PHR is determined at least according to a physical uplink shared channel (PUSCH) transmission transmitted with the two joint or uplink common TCI states simultaneously in the slot.

15. A method performed by a user equipment (UE), the method comprising:
receiving information indicating two joint or uplink common transmission configuration indication (TCI) states applicable in a slot of an activated bandwidth part (BWP) of a serving cell; and
transmitting at least one power headroom report (PHR) in the slot for the activated BWP of the serving cell, wherein the at least one PHR is determined at least according to a physical uplink shared channel (PUSCH) transmission transmitted with the two joint or uplink common TCI states simultaneously in the slot.

16. The method of claim 15, wherein,
each frequency resource block of the PUSCH transmission is transmitted with a corresponding one of the two joint or uplink common TCI state, and only one PHR in the slot is transmitted,
wherein, the PHR is determined according to a first joint or uplink common TCI state of the two joint or uplink common TCI states and a number of resource blocks of the PUSCH transmission associated with the first joint or uplink common TCI state.

17. The method of claim 15, wherein,
each frequency resource block of the PUSCH transmission is transmitted with a corresponding one of the two joint or uplink common TCI state, and only one PHR in the slot is transmitted,
wherein, the PHR is determined according to a number of frequency resource blocks of the PUSCH transmission associated with a sounding reference signaling (SRS) resource set with a lower identifier (ID) of two SRS resource sets configured for the activated BWP and a joint or uplink common TCI state associated with the SRS resource set with the lower ID.

18. The method of claim 15, wherein,
each frequency resource block of the PUSCH transmission is transmitted with a corresponding one of the two joint or uplink common TCI state, and only one PHR in the slot is transmitted,
wherein, the PHR is determined according to a joint or uplink common TCI state of the two joint or uplink common TCI states and a number of frequency resource blocks of the PUSCH transmission associated with the joint or uplink common TCI state.

19. The method of claim 15, wherein,
a part of layers of the PUSCH transmission is transmitted with a first joint or uplink common TCI state of the two joint or uplink common TCI states and another part of the layers of the PUSCH transmission is transmitted with a second joint or uplink common TCI state of the two joint or uplink common TCI states or each layer of the PUSCH transmission is transmitted with the two joint or uplink TCI states, and only one PHR in the slot is transmitted,
wherein, the PHR is determined according to a number of resource blocks of the PUSCH transmission and the first joint or uplink common TCI state.

20. A method performed by a radio access network (RAN) node, the method comprising:
transmitting information indicating two joint or uplink common transmission configuration indication (TCI) states applicable in a slot of an activated bandwidth part (BWP) of a serving cell; and
receiving at least one power headroom report (PHR) in the slot for the activated BWP of the serving cell, wherein the at least one PHR is determined at least according to a physical uplink shared channel (PUSCH) transmission transmitted with the two joint or uplink common TCI states simultaneously in the slot.
